(19) United States
(12) Patent Application Publication
(10) Pub. No.: US 2017/0017846 A1
(43) Pub. Date: Jan. 19, 2017

(54) CROWD AND TRAFFIC MONITORING APPARATUS AND METHOD

(71) Applicant: Umm Al-Qura University, Makkah (SA)

(72) Inventors: Emad FELEMBAN, Makkah (SA); Adil A. SHEIKH, Makkah (SA); Muhammad SAQIB, Makkah (SA)

(73) Assignee: Umm Al-Qura University, Makkah (SA)

(21) Appl. No.: 14/799,723

(22) Filed: Jul. 15, 2015

(51) Int. Cl. G06K 9/00

(52) U.S. Cl. CPC G06K 9/00785; G06K 9/00778

(57) ABSTRACT

An apparatus and method for monitoring mixed pedestrian and motor vehicle traffic. The apparatus include an optical camera, an infrared camera, and a wireless-device counter, each obtaining complementary information regarding the crowd density and flow of the traffic. Performing heat signature analysis and blob detection of the infrared image data to discriminate pedestrians from motor vehicles. Performing optical flow computations with Gaussian pyramids, Histogram of Oriented Gradients calculations, support vector machine (SVM) classifications, and correlation-based clustering using the optical images to determine the crowd density and flow of pedestrians. Incorporating the (SVM) classifications with the blob detection to differentiate pedestrians from motor vehicles. Obtaining an estimate of the number of wireless devices using the wireless-device counter as an additional indicator of the number of pedestrians and motor-vehicles. Finally, combining the above-identified regarding the crowd density and flow to create an improved traffic estimate.

### BACKGROUND

A major challenge of crowd management is estimating the number of people and vehicles passing through a given corridor or street. Determining the number of people and vehicles has broad applications in various situations and scenarios. This estimation of traffic density and flow becomes even more difficult in the presence mixed pedestrian and motor vehicle traffic.

Both Bluetooth® or Wi-Fi® access points can be used to count the number of devices within a given area using their respective technologies and protocols to spoof Bluetooth® or Wi-Fi® compatible devices into broadcast their respective MAC addresses, for example. When Bluetooth is enabled in a communication device, the device attempts to pair with other Bluetooth devices by broadcasting its MAC address. Counting the distinct MAC addresses within the detection range of an access point enables an estimate of the number of Bluetooth devices within the detection area and by extension the number of people and/or vehicles within the detection area can also be estimated, assuming there are on average N people per Bluetooth compatible wireless device. Similarly, Wi-Fi access points can be used for counting the number of Wi-Fi devices within a Wi-Fi access region. One limitation of Bluetooth and Wi-Fi counters is that these access points cannot differentiate between pedestrians and motor vehicles using Wi-Fi/Bluetooth devices.

Another method of estimating crowds uses optical cameras and image recognition/processing methods to estimate the crowd density. Camera systems and software can be used to count, track and detect speed of people. Additionally, similar camera systems can be used to count, track and detect speed of vehicles. However, conventional camera systems cannot count, track and detect the number/density and speed of people and simultaneously track and detect the number/density and speed motor vehicles.

### SUMMARY

According to aspects of one embodiment, there is provided a traffic-monitoring controller, that includes (i) an interface configured to receive optical-image data and device-count data; and (ii) processing circuitry configured to (1) obtain, using the interface, the optical-image data representing an optical image of the first area, (2) obtain, using the interface, the device-count data representing device-identification information corresponding to wireless devices detected by a receiver, wherein the detected wireless devices are within a second area corresponding to an area within a wireless communication range of the receiver, and the device-count data further represents time information corresponding to when the wireless devices were respectively detected, (3) determine, using the optical-image data, a first pedestrian estimate indicating a number of pedestrians in the first area, (4) determine, using the device-count data, a pedestrian-and-motor-vehicle estimate indicating a number of pedestrians and motor vehicles in the second area, and (5) determine, using the first pedestrian estimate and the pedestrian-and-motor-vehicle estimate, a first motor-vehicle estimate of a number of motor vehicles in the first area, wherein (6) the second area overlaps the first area.

According to further aspects, there is provided that the processing circuitry is further configured to (1) obtain, using the interface, thermal-image data representing an infrared image of the first area, (2) determine, using the thermal-image data, a second pedestrian estimate of the number of pedestrians in the first area, (3) determine, using the thermal-image data, a second motor-vehicle estimate of the number of motor-vehicles in the first area, (4) determine a combined pedestrian estimate of the number of pedestrians in the first area by using the first pedestrian estimate and the second pedestrian estimate, and (5) determine a combined motor-vehicle estimate of the number of motor vehicles in the first area by using the first motor-vehicle estimate and the second motor-vehicle estimate.

According to aspects of another embodiment, there is provided a traffic-monitoring method that includes (i) imaging a first area, using an optical camera, to generate optical-image data representing an optical image of the first area; (ii) imaging a first area, using an infrared camera, to generate thermal-image data representing an infrared image of the first area; (iii) receiving, using a receiver, device-identification information corresponding to wireless devices within a second area in a wireless communication range of the receiver, (iv) generating device data representing the device-identification information and representing a time that the device-identification information was received; (v) determining, using the optical-image data, a first pedestrian estimate indicating a number of pedestrians in the first area; (vi) determining, using the wireless-device data, a pedestrian-and-motor-vehicle estimate indicating a number of pedestrians and motor vehicles in the second area; and (vii) determining, using the a first pedestrian estimate and the pedestrian-and-motor-vehicle estimate, a first motor-vehicle estimate of a number of motor vehicles in the first area, wherein (viii) the second area overlaps the first area.

### BRIEF DESCRIPTION OF THE DRAWINGS

A more complete understanding of this disclosure is provided by reference to the following detailed description when considered in connection with the accompanying drawings, wherein:

FIG. 1 shows a schematic diagram of a traffic-monitoring apparatus, according to one embodiment;

FIG. 2 shows a schematic diagram of a processor, according to one embodiment;

FIG. 3 shows a mixed pedestrian and motor vehicle environment including multiple traffic-monitoring apparatuses, according to one implementation;

FIG. 4 shows a flow diagram of a method of using a traffic-monitoring apparatus to estimate traffic flow and crowd density, according to one implementation;

FIG. 5 shows a flow diagram of another implementation of a method of using a traffic-monitoring apparatus to estimate traffic flow and crowd density, according to one implementation;

FIG. 6 shows a schematic diagram of another embodiment of a processor; and

FIG. 7 shows a schematic diagram of an exemplary cloud computing implementation of a system of traffic-monitoring apparatus.

### DETAILED DESCRIPTION

The apparatus and methods described herein illustrate a comprehensive solution that can detect, count, track and calculate the speed of pedestrians and motor vehicles in mixed traffic scenarios.

Crowd densities and flow information regarding pedestrian and motor vehicles traffic can be useful in many applications. For example, decision makers can use this information to control and manage pedestrian flows in order to reduce travel time and associated cost. Such systems can be reactive to pedestrians' needs in a given venue by, e.g. closing or opening additional doors, ticket shops, or control gates. Thus, crowd densities and flow information provides guidance regarding the degree of capacity utilization, and can provide information for directing pedestrian flows to desired destination using less crowded pathways to achieve time savings and more efficiently use resources. Furthermore, such crowd information is also very interesting and useful for commercial purposes (e.g., advertising).

In addition to optical methods of crowd density estimation, Wi-Fi infrastructures are increasingly being installed in many public buildings to provide internet and other services to tenants and visitors. More people are using smartphones and tablets compatible with Wi-Fi and related wireless and/or short-range communication (SRC) networks and protocols (e.g., Bluetooth, RFID, and Near-field communication (NFC)). The increasing usage of these communication technologies creates the possibility of estimating traffic flows by monitoring the signals from these user terminals (e.g., smartphones and tablets). For example, Wi-Fi enabled devices periodically broadcast certain management frames, which can be used to passively monitor the presence terminal devices as an indication of the presence of users. This Wi-Fi data can be exploited to locate and track people, and this tracking data can in turn be used for density and trajectory/flow estimations. Crowd density is generally defined as the quantity of people per unit of area at a given time or time interval. Relatedly, traffic/pedestrian flow is generally defined as the average number of people/motor vehicles moving one way through an area of interest within a certain time interval.

Estimation methods based on Bluetooth and Wi-Fi signal monitoring can be used to determine pedestrian flows, but the correlation between Wi-Fi signals and an actual number of pedestrians is not exact. Therefore, higher accuracy and higher fidelity measurements of crowd density and flow will benefit from a hybrid approach using both optical and wireless terminal device signals. Furthermore, the complexity of the estimation of crowd density and flow becomes greater when mixed traffic of pedestrians and motor vehicles are considered. Conventional approaches are poorly adapted to solving the problem of separating pedestrian and motor vehicle traffic when using either terminal device counting or optical methods for crowd density and flow estimations.

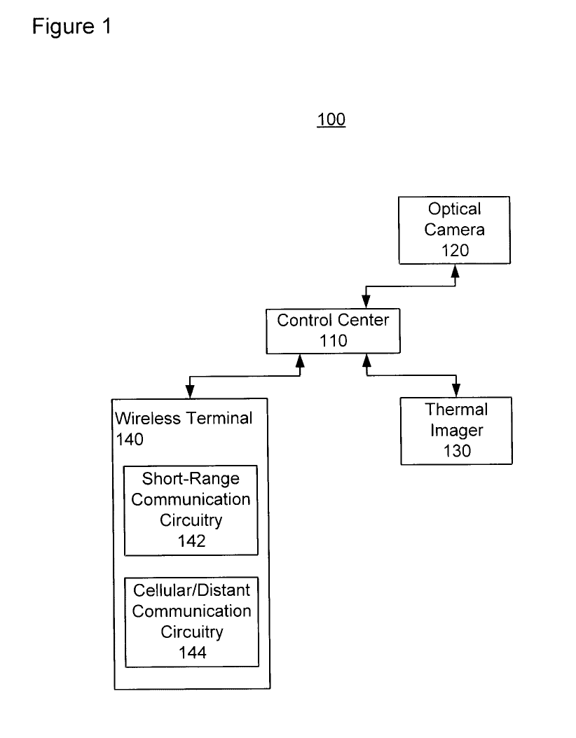

Referring now to the drawings, wherein like reference numerals designate identical or corresponding parts throughout the several views, FIG. 1 shows a traffic-monitoring apparatus 100 for estimating crowd densities in a mixed pedestrian and motor vehicle environment. The apparatus can function to estimate the crowd density and flow of mixed pedestrian and motor vehicle traffic, and to parse the motor vehicle density and flow from the pedestrian density and flow. “Pedestrian” includes human traffic as well as other animal traffic such as horses, camels, etc. In one embodiment, the traffic-monitoring apparatus 100 includes a control center 110 that combines signals from a multiplicity of sensors and devices and processes the signals to provide estimates of the traffic density and flow. Further, the control center 110 can transmit data and processing results to other traffic-monitoring apparatuses or to a cloud computing platform receiving data from multiple traffic-monitoring apparatuses, for example, in order to collaborate and combine results from several traffic-monitoring apparatuses to refine and improve the traffic estimates.

The traffic-monitoring apparatus 100 includes an optical camera 120 to obtain optical images of a traffic corridor. The traffic corridor can include any location where pedestrians on foot and/or in motor vehicles congregate and/or pass through/move, for example, bazar, flee market, shopping center, an entrance/exit at a sporting venue, a concert venue, a religious venue, a street, a sidewalk, a hallway, a foyer, entryway, lobby, mall, or other place in which a large number of people and/or motor vehicles are likely to be found. In one implementation, the optical camera 120 can include multiple cameras, and might also include software to preprocess the image data. For example, pre-processing software could include stitching together multiple images, or partitioning the images into smaller sections, as would be understood by one of ordinary skill in the art.

The traffic-monitoring apparatus 100 includes a wireless terminal 140. The wireless terminal 140 can be used for detecting wireless signals from user equipment such as cellphones, smartphones, tablets, and car devices, in order to detect the presence of these devices. Additionally, the wireless terminal 140 can be used to communicate with devices such as a cloud computing center and with other traffic-monitoring apparatuses. In one implementation, a wired network connection is used for network communications, rather than a wireless network connection. The wireless terminal 140 can include both short range communication (SRC) circuitry 142 and cellular/distant communication circuitry 144.

In one implementation, Wi-Fi communication is performed using the SRC circuitry 142. In another implementation, Wi-Fi communication is performed using the cellular/distant communication circuitry 144. The SRC circuitry 142 can be used for sending and receiving Wi-Fi signals, Bluetooth signals, radio-frequency identification (RFID) signals, near-field communication (NFC) signals, and/or WiMAX signals. The SRC circuitry 142 can also be used to send and receive short range communication signal using various technologies, protocols, and standards understood by one of ordinary skill in the art.

WiMAX (Worldwide Interoperability for Microwave Access) is a wireless communications standard configured to currently provide 30 to 40 megabit-per-second data rates, and refers to interoperable implementations of the IEEE 802.16 family of wireless-networks standards. Near field communication (NFC) enables smartphones and other devices to establish radio communication with each other by touching the devices together or bringing them into proximity to a distance of conventionally 10 cm or less. For example, NFC can employ electromagnetic induction between two loop antennae when NFC devices to exchange information, operating within the globally available unlicensed radio frequency ISM band of 13.56 MHz on ISO/IEC 18000-3 air interface and at rates ranging from 106 kbit/s to 424 kbit/s. Radio-frequency identification (RFID) is the wireless use of electromagnetic fields to transfer data, for the purposes of automatically identifying and tracking tags attached to objects. The tags contain electronically stored information. Some tags are powered by electromagnetic induction from magnetic fields produced near the reader. Wi-Fi is a local area wireless computer networking technology that allows electronic devices to network, for example using the 2.4 GHz UHF and 5 GHz SHF ISM radio bands. Wi-Fi can be any wireless local area network” (WLAN) product based on the Institute of Electrical and Electronics Engineers' (IEEE) 802.11 standards, for example. Bluetooth is a wireless technology standard (originally under the IEEE 802.15.1 standard) for exchanging data over short distances (using short-wavelength UHF radio waves in the ISM band from 2.4 to 2.485 GHz) from fixed and mobile devices, and building personal area networks (PANs). Bluetooth was originally used as a wireless alternative to RS-232 data cables. Bluetooth can connect several devices, overcoming problems of synchronization.

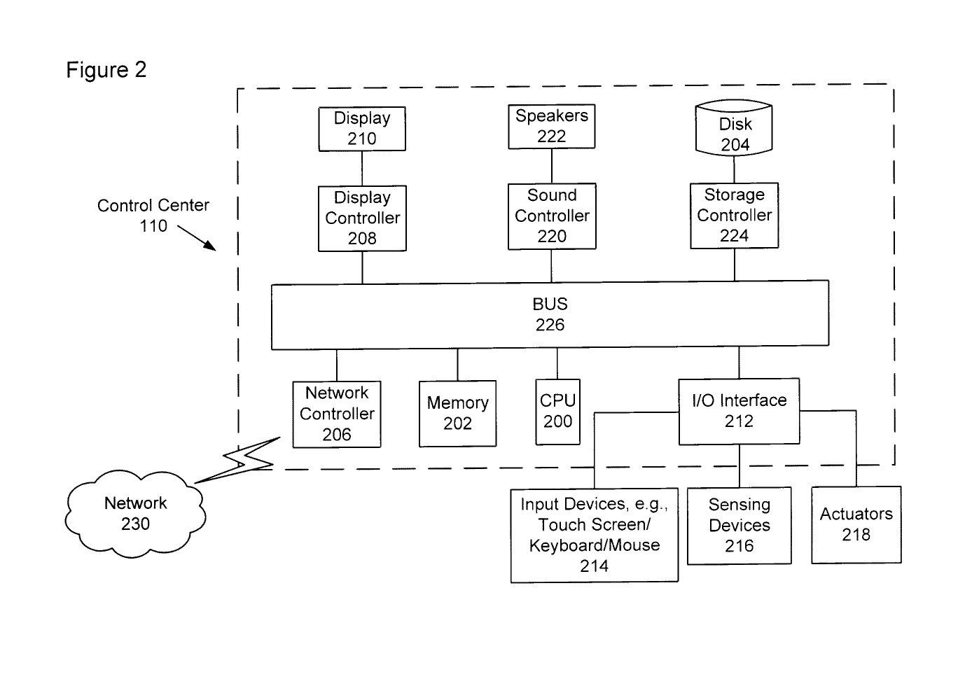

FIG. 2 provides an example schematic drawing of the control center 110. In FIG. 2, the control center 110, which in select embodiments is a server, includes a CPU 201 which performs the processes described above including method 100 and the integration of the acquired intensity/irradiance data. The process data and instructions may be stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the control center 110 communicates, such as a server or computer.

Further, the claimed advancements may be provided as a utility application, background daemon, or component of an operating system, or combination thereof, executing in conjunction with CPU 201 and an operating system such as Microsoft Windows 7, UNIX, Solaris, LINUX, Apple MAC-OS and other systems known to those skilled in the art.

CPU 201 may be a Xenon or Core processor from Intel of America or an Opteron processor from AMD of America, or may be other processor types that would be recognized by one of ordinary skill in the art. Alternatively, the CPU 201 may be implemented on an FPGA, ASIC, PLD or using discrete logic circuits, as one of ordinary skill in the art would recognize. Further, CPU 201 may be implemented as multiple processors cooperatively working in parallel to perform the instructions of the inventive processes described above. The control center 110 in FIG. 2 also includes a network controller 206. As can be appreciated, the network 230 can be a public network or a private network such as an LAN or WAN network. The network 230 can be wireless such as a cellular network including EDGE, 3G and 4G wireless cellular systems. The wireless network 230 can also be Wi-Fi, Bluetooth, or any other wireless form of communication that is known.

The control center 110 further includes a display controller 208 for interfacing with display 210. A general purpose I/O interface 212 interfaces with an input device(s) 214 (e.g., the input devices can include a touch screen, a keyboard, and/or a mouse) as well as sensing devices 216 and actuators 218. The sensing devices 216 can include the optical camera 120, the thermal imager 130, the wireless terminal 140 and the SRC circuitry 142. In one implementation, the bus 226 directly interfaces with the optical camera 120, the thermal imager 130, the wireless terminal 140 and the SRC circuitry 142.

A sound controller 220 is also provided in the control center 110 to interface with speakers/microphone 222 thereby providing sounds. In one implementation, the sound controller 220 and the speakers/microphone 222 are optional.

The general purpose storage controller 224 connects the storage medium disk 204 with communication bus 226, which may be an ISA, EISA, VESA, PCI, or similar, for interconnecting all of the components of the control center 110. A description of the general features and functionality of the display 210, keyboard, touch screen, and/or mouse 214, as well as the display controller 208, storage controller 224, network controller 206, sound controller 220, and general purpose I/O interface 212 is omitted herein for brevity as these features are known.

In certain implementations, the control center 110 will perform the methods described herein, and in other implementations the methods described herein can be performed using distributed or cloud computing, in which case the control center 110 can direct some of the more computationally and memory intensive tasks, for example, to a cloud-computing center. Thus, the methods described herein can be divided between the control center 110 and other processors. The other processors can communicate with the control center 110 via a networked connection using the network 230, for example.

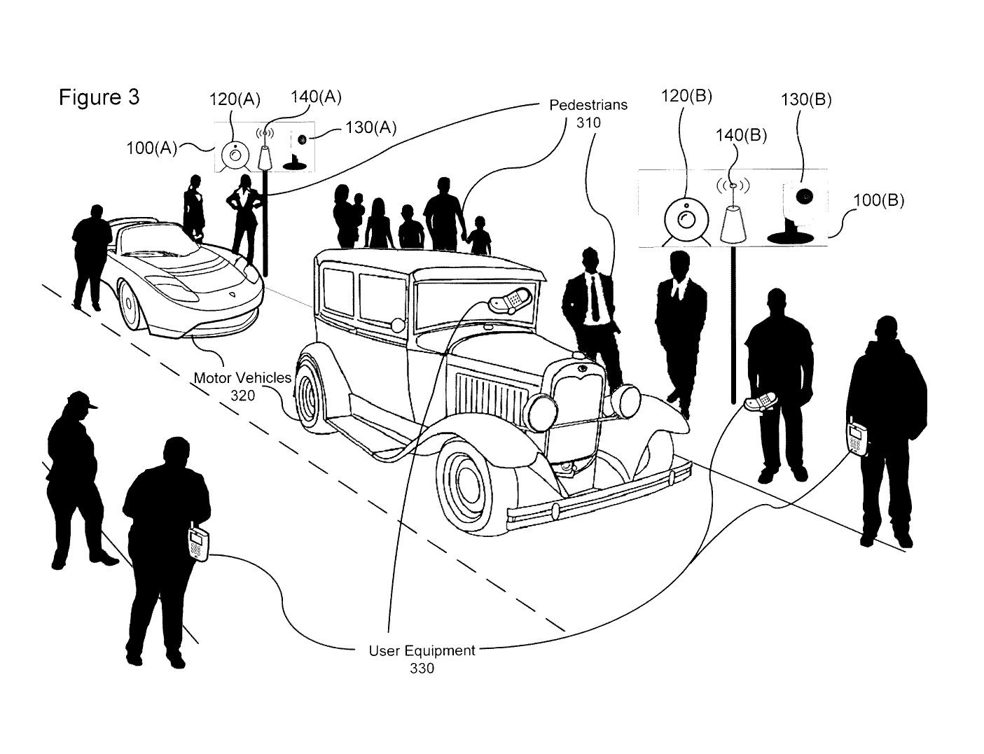

FIG. 3 shows a mixed-traffic environment that includes a mixture of pedestrians 310 and motor vehicles 320. The pedestrians 310 and motor vehicles 320 can be carrying user equipment 330 that has Wi-Fi or Bluetooth capability, and the motor vehicles 320 can also have built-in wireless capabilities (e.g., OnStar®, Wi-Fi, and/or Bluetooth). The user equipment 330 can include cellphones, personal digital assistants, electronic organizers, smartphones, smartwatches, smartglasses, wearable technology, tablets, laptop computers, or other personal devices having Wi-Fi, Bluetooth, RFID, wireless, or related noncontact communication capabilities.

FIG. 3 also shows a first traffic-monitoring apparatus 100(A) and a second traffic-monitoring apparatus 100(B) separated by a distance. The first traffic-monitoring apparatus 100(A) includes an optical camera 120(A), a thermal imager 130(A), and a wireless terminal 140(A). The control center is not shown for traffic-monitoring apparatuses 100(A) and 100(B). In certain implementations, the control center can be collocated with the optical camera 120(A), the thermal imager 130(A), and the wireless terminal 140(A); while in other implementations the control center can be a remotely located server, for example. The second traffic-monitoring apparatus 100(B) also includes an optical camera 120(B), a thermal imager 130(B), and a wireless terminal 140(B). The second traffic-monitoring apparatus 100(B) can also include a co-located or remotely located control center. Further, when the control center is co-located with the optical camera 120(B), the thermal imager 130(B), and the wireless terminal 140(B), the control center can perform functions and methods described herein can be partially performed using the control center and partially performed by sending the data to a server that performs another part of the functions and methods described herein. These traffic-monitoring apparatuses 100(A) and 100(B) can detect and monitor the density and flow of traffic (both pedestrian and motor vehicular) among their respective communication zones/ranges. For example, each of the traffic-monitoring apparatuses 100(A) and 100(B) monitors the MAC addresses of devices within their respective communication ranges. They may do this using a single technology (e.g., Wi-Fi only) or using multiple technologies (e.g., Wi-Fi, Bluetooth, and RFID).

In one implementation, when a Bluetooth or Wi-Fi enabled device comes within the wireless communication/transmission range of a respective traffic-monitoring apparatus 100, as shown in FIG. 3, the These traffic-monitoring apparatus 100 captures the device's MAC address. The first and second traffic-monitoring apparatuses 100(A) and 100(B) can each have a respective clock, and the clocks can be synchronized using a Time Server using network time protocol (NTP), for example. Each apparatus 100(A) and 100(B) will capture the MAC address and the corresponding time stamp information of passing vehicle within its wireless range. Each apparatus 100(A) and 100(B) will store the MAC address and time stamp in a local memory, or send the MAC address to a server where the MAC address is stored.

In a real-time implementation, both traffic-monitoring apparatuses 100(A) and 100(B) transmit the time and location information to the server, for example. Using the time difference between when a MAC address is detected by the respective traffic-monitoring apparatuses 100(A) and 100(B), the server calculates an average travel time and speed between the traffic-monitoring apparatuses 100(A) and 100(B). This way the server is able to provide real-time information regarding the number of vehicles passing through the corridor, as well as flow related information such as the average speed and variation of the speeds of the motor vehicles and the pedestrians respectively.

In a post-processing implementation, the server saves the MAC addresses and time stamp information and traffic flow information and performs the processing later. In the post-processing implementation, the server is able to communicate to users the traffic flow information using the saved MAC addresses. In certain implementations, the real-time implementation can also cause the server to communicate to users the traffic flow information using the saved MAC addresses.

Further processing can be performed on the provided traffic information in order to deduce the information patterns of traffic flow and derive predictive estimations, for example.

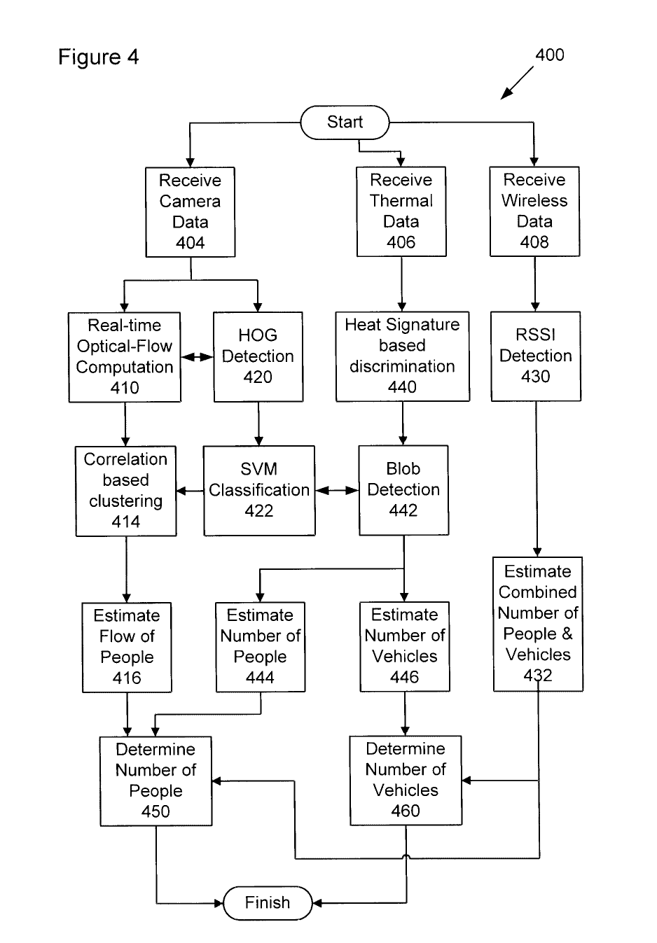

FIG. 4 shows a traffic estimation method 400. The first steps are the control center 110 receiving the camera data 404, receiving the thermal data 406, and receiving the wireless data 408.

The received camera data is processed using two different methods. The camera data represents an optical image of the area surrounding the traffic estimation apparatus 100. This surrounding image can be obtained, for example, using a fish-eye lens, by stitching together multiple images from more than one camera sensor, or by scanning the field of view of a camera using an actuator 218. The first method of traffic estimation begins using a real-time optical flow computation in step 410 of method 400. In one implementation, step 410 is performed using a method adapted from the real-time optical flow algorithm developed by Horn-Schunck in order to determine the optical flow field. The optical flow field is a set of independent flow vectors based on their spatial location in frames of the video. At least, two consecutive frames are used to determine motion flow field. Optical flow computation calculates the motion vectors for all the pixels in the frame. In one implementation, most of the flow vector will have a low magnitude, and therefore will be considered to be background. Accordingly, a predefined threshold is used to select out the noise/background regions which can be treated separately in order to reduce computational costs.

In one implementation, the optical flow computation includes the assumption that movement of an object between two frames should be very small. Based on this assumption, a Gaussian Pyramid technique can be used with optical flow calculation to detect and track large movements between frames.

Optical flow describes the pattern of apparent motion of objects, surfaces, and edges in a visual scene caused by the relative motion between camera and the scene, for example. Optical flow calculates the motion between two image frames which are taken at different times using differential comparison of the pixels. Several methods can be used for the optical flow calculation, including: phase correlation methods, block-based methods, the Lucas-Kanade method, the Horn-Schunck method, the Buxton-Buxton method, and the Black Jepson method. In on implementation, a Horn-Schunck method or a variation of the Horn-Schunck method is used. The optical flow can be estimated using a global method which introduces a global constraint of smoothness to solve the aperture problem. This assumes smoothness in the flow over the whole image, and therefore tries to minimize distortions in flow by favoring solutions which show greater smoothness. The flow is formulated as a global-energy functional, and the desired solution minimizes the global-energy functional. In one implementation, the method optimizes the global-energy functional based on residuals from the brightness constancy constraint, and a predefined regularization term expressing the expected smoothness of the flow field. Accordingly, this method yields a high density of flow vectors.

In step 420 of method 400, a Histogram of Oriented Gradients (HOG) algorithm is performed using the camera data and the optical flow vectors to detect image regions associated with pedestrians and/or motor vehicles. For example, pedestrians can be detected using a histogram method of U.S. patent application Ser. No 12/566,580, incorporated herein by reference in its entirety. In one implementation, the pedestrian detection can be performed using the method disclosed in N, Dalal and B. Triggs “Histograms of Oriented Gradients for Human Detection”, Proc. 2005 IEEE Conference on Computer Vision and Pattern Recognition, pp. 886-893, Volume 1, (2005), incorporated herein by reference in its entirety. In one implementation, all the flow vectors corresponding to one detected human should be mapped to single flow vector cluster. This single vector cluster is then designated by a dominant vector representing, for example a pedestrian or motor vehicle, detected using the HOG algorithm. Information regarding the optical flow computation can be passed from step 410 to step 420, and reciprocally information regarding the optical HOG analysis can be passed from step 420 to step 410.

In step 414 of method 400, correlation based clustering is used to further refine and detect movements of pedestrians and motor vehicles. To determine the dominant flow directions, similarity criteria are used to group or cluster the flow vector corresponding to same flow. For example, K-mean clustering can be used to cluster the flow vectors corresponding to the pedestrians or motor vehicles, for example, detected by the HOG algorithm in step 420. In one implementation, all the flow vectors corresponding to each pedestrian or motor vehicle will be represented by one single vector.

In step 414 of method 400, clustering provides a method of partitioning data points into groups based on their similarity. For example, correlation clustering can provide a method for clustering a set of objects into the optimum number of clusters without specifying that number of clusters in advance. In one implementation, k-means clustering is used. This k-means clustering provides a method of vector quantization. In one implementation, this is performed by partitioning n observations into k clusters in which each observation belongs to the cluster with a corresponding nearest mean, serving as a prototype of the cluster. This results in a partitioning of the data space into Voronoi cells. Efficient heuristic algorithms can be used to provide rapid convergence to a locally optimum solution. In one implementation, these heuristic algorithms can be modeled after the expectation-maximization algorithm for mixtures of Gaussian distributions via an iterative refinement approach employed by both algorithms.

Additionally, heuristic algorithms can be used to create cluster centers to model the data; however, k-means clustering can tend to find clusters of comparable spatial extent, while the expectation-maximization mechanism allows clusters to have different shapes, for example. In one implementation, the k-means clustering problem can be formulated as using a set of observations (e.g., each observation is a d-dimensional real vector) to obtained, k-means clustering, wherein the clusters aim to partition the observations into k sets that minimize the within-cluster sum of squares (WCSS). Generally, clustering and especially k-means clustering are well known, and thus the description herein is kept brief.

In step 422 of method 400, the method of determining the single vector corresponding to a pedestrian or motor vehicle includes the further step of performing pattern recognition and machine learning using a support vector machine (SVM) classifier. Thus, the dominant vector corresponding to a pedestrian or motor vehicle is detected using the HOG algorithm in step 420 followed by applying a SVM classifier in step 422.

In one implementation, the SVM classifier can also be used to divide the dominant flow directions into four Cartesian quadrants based on their angle information obtained during optical flow computation of step 410. In steps 420 and 422, method 400 is able to estimate the number of pedestrian/motor vehicles using the HOG algorithm and the SVM classifier in the mixed the pedestrian or motor vehicle. Additionally, the combination of flow information resulting from the optical-flow calculation and the density information resulting from the HOG detection enables method 400 to determine the flow densities of pedestrians (and possibly for motor vehicles) moving in four quadrant directions using the Cartesian quadrant system.

The estimation of the flow of people (e.g., pedestrians and those not in motor vehicles, such as a cyclist or person riding on a camel, horse, or Segway®) can be performed in step 416.

The SVM classifier can be one of a set of generally related supervised learning methods that analyze data and recognize patterns, used for classification (machine learning)|classification and regression analysis. The SVM classifier can be a non-probabilistic binary classifier, according to one implementation. For example, in a binary linear classifier the SVM classifier can predict, for each given input, which of two possible classes the input is a member of Since an SVM is a classifier, then given a set of training examples, each marked as belonging to one of two categories, an SVM training algorithm builds a model that predicts whether a new example falls into one category or the other. Thus, the SVM model represents the examples (i.e., the training data) as points in space, mapped so that the examples of the separate categories are divided by a clear gap that is as wide as possible. New examples are then mapped into that same space and predicted to belong to a category based on which side of the gap they fall on. Stated differently, a SVM constructs a hyperplane or set of hyperplanes in a high or infinite dimensional space, which can be used for classification, regression or other tasks. A good separation is achieved by obtaining a hyperplane that has the largest distance to the nearest training data points of any class.

In one implementation, the HOG algorithm calculates an HOG descriptor using the appearance and shape of a local object within an image to create the HOG descriptor in order to describe the distribution of intensity gradients or edge directions. The image is divided into small connected regions called cells, and for the pixels within each cell, a histogram of gradient directions is compiled. The descriptor is then the concatenation of these histograms. In one implementation, the local histograms can be contrast-normalized by calculating a measure of the intensity across a larger region of the image, called a block, and then using this value to normalize all cells within the block. This normalization results in better invariance to changes in illumination and shadowing.

The HOG descriptor has a few key advantages over other descriptors. Since it operates on local cells, the HOG descriptor is invariant to geometric and photometric transformations, except for object orientation. Such changes would only appear in larger spatial regions. Moreover, coarse spatial sampling, fine orientation sampling, and strong local photometric normalization permits the individual body movement of pedestrians to be ignored so long as they maintain a roughly upright position. The HOG descriptor is thus particularly well suited for human detection in images.

In one implementation, the HOG algorithm performs the steps of gradient computation, orientation binning, descriptor block computations and block normalization before classifying the blocks as either pedestrian, motor vehicle, or other, for example.

The final step in object recognition using histogram of oriented Gradient descriptors is to feed the descriptors into some recognition system based on supervised learning. The SVM classifier provides a binary classifier which looks for an optimal hyperplane as a decision function. Once trained on images containing some particular object, the SVM classifier can make decisions regarding the presence of an object, such as a pedestrian, motor vehicle, or other, for example. Thus, in one implementation, the steps of HOG detection and SVM classification are not clearly separated, and the steps 420 and 422 can overlap and blend together.

In one implementation, the HOG algorithm is applied to the problem of human detection in films and videos. For example, the HOG descriptors for individual video frames can be combined with internal motion histograms (IMH) on pairs of subsequent video frames. These IMHs use the gradient magnitudes from optical flow_fields obtained from two consecutive frames. These gradient magnitudes are then used in the same manner as those produced from static image data within the HOG descriptor approach, for example. Thus, in one implementation, the steps of HOG detection and optical-flow calculations are not clearly separated and these steps 410 and 420 also can overlap and blend together.

In step 430 of method 400, analysis of wireless signals from user equipment and devices equipped with wireless technologies such as Wi-Fi, Bluetooth, and RFID is performed in order to discern the number (and in certain implementations the positions) of devices within the detection range of a traffic-monitoring apparatus 100. As shown in FIG. 3, multiple traffic-monitoring apparatuses 100 can be arranged within an area of interest. In one implementation, these traffic-monitoring apparatuses 100(A) and 100(B) will perform received signal strength indication (RSSI) detection using the signal strength of the wireless signals and using the MAC addresses and time stamp information of the detected signals. Alternatively, the detection performed in step 430 does not require a measurement of the strength of the received wireless signals, but instead uses the detection of MAC addresses and the corresponding time stamps.

For example, two traffic-monitoring apparatuses 100 can be positioned along a road-side at predefined locations and at a predefined height. Further, these traffic-monitoring apparatuses 100 can be arranged at a predefined distance relative one to the other. Many low power wireless communications devices are available in vehicles, including in-vehicle navigation systems, mobile GPS systems, and cellular phones. Whenever Bluetooth or Wi-Fi possessing motor vehicle or pedestrian come into the range of these devices, as shown in FIG. 3, the traffic-monitoring apparatus 100 captures MAC address corresponding to the respective wireless device. Determining crowd density can be performed uses only the MAC addresses to count the number of unique MAC addresses within the predefined wireless communication range.

However, determining crowd flow additionally uses timing information and can use MAC addresses and timing information from more than one traffic-monitoring apparatus arranged in relative proximity. For flow determination, the clocks of the traffic-monitoring apparatuses 100 are synchronized using, e.g., a Time Server using NTP protocol. Each traffic-monitoring apparatus 100 captures the MAC address and the time stamp information of the passing wireless devices, and the MAC address and time stamp are compared, for example, by transmitting the captured information to a common/master traffic-monitoring apparatus 100 that performs a comparison and analysis of the movement and timing of movements for wireless devices among the respective areas of the traffic-monitoring apparatuses. Alternatively, all of the traffic-monitoring apparatuses can transmit their respective information to a cloud computing center, where the comparison and analysis are performed of the movement and timing of movements for wireless devices among the respective areas of the traffic-monitoring apparatuses. Knowing the timing of these movements and the relative distances between the traffic-monitoring areas (i.e., the area is determined by the communication range of each traffic-monitoring apparatus) the rate of movement of the wireless devices can be estimated.

In one implementation, the traffic-monitoring apparatuses 100 store the MAC addresses in memory (e.g., a local memory such as disk 204 or memory 202). The traffic-monitoring apparatuses 100 prevent redundant storing of the MAC address because each time a MAC address is broadcast by the user equipment the traffic-monitoring apparatus 100 compares the detected MAC addresses against recently stored MAC addresses. If the MAC address matches a previously stored MAC address, then the MAC address is not stored again, but instead the time stamp is stored in association with the previously stored MAC address. To clear out old MAC addresses, previously stored MAC addresses that have not been detected after a predefined time window can be removed from memory. This method of storing MAC addresses has the advantage of conserving memory space and bandwidth for transmission to the common MAC address comparison and analysis center (e.g., the server).

In real-time applications, the traffic-monitoring apparatuses 100 transmit the MAC addresses, time, and location information to a server. The server then calculates average travel-time and speed for a particular traffic corridor, for example. Thus, the server is able to provide real-time information regarding the number of vehicles/pedestrians passing through the corridor and additional provide information regarding the approximate speed/flow. For post processing applications, the servers store the MAC address and other information for future processing. Thus, the server can convey to users the processed traffic flow information based on past records of the stored MAC addresses.

As discussed above, pedestrian and motor vehicle tracking can be performed using, e.g., Bluetooth or Wi-Fi signals. For example, density estimation of highly populated events having large crowds, such as at a music concert, can be realized using Bluetooth scans or Wi-Fi from collaborating smartphones inside the crowd. When enough devices from the crowd are cooperating, the density and motion of surrounding people can be deduced, for example, from the result of the respective devices building a Bluetooth ad-hoc network. However, Bluetooth has a short transmission range and most modern smartphones operate Bluetooth in invisible mode per default. Thus, Wi-Fi, which can operate over longer ranges can provide complementary information to that obtained via Bluetooth. Empirically, Wi-Fi crowd data appears to benefit from shorter discovery time and higher detection rates than Bluetooth

Crowd density and flow can be estimated using Bluetooth and Wi-Fi or other wireless or SRC communication systems. Bluetooth is a wireless communication system designed for short range communication and operates in the license-free ISM band, as discussed in standard IEEE 802.15.1. The conventional range of Bluetooth-enabled smartphones is approximately ten meters. A device seeking to initiate a Bluetooth connection with another device sends out an inquiry packet and listens for an answer to their inquiry. In one implementation, a listening device reacts to the inquiry packet, when the inquiry packet is made visible by the user through a user interface dialog of the listening device. The inquiry response frame contains the Bluetooth MAC identifier of the discovered device and can contain additional information including the local name of a device.

Wi-Fi is defined in standard IEEE 802.11. The Wi-Fi communication range can vary between 35 meters for indoor scenarios to more than 100 meters for outdoor scenarios, depending on the environment, the Wi-Fi transmitter power, and the used 802.11 protocol extension. The Wi-Fi standard defines three different classes of frames: Control frames, management frames, and data frames. Wi-Fi discovery includes passive scanning in which a mobile device listens for messages from access points advertising their presence. To become detectable, an access point sends out beacon frames roughly every 100 msec. These frames are sent out on the operation channel, such that clients will listen to multiple different operation channels in order to passively find access points. In contrast to passively finding access points, active scanning is based on messages sent by terminal devices similar to a Bluetooth inquiry message. These messages are sequentially sent out on each operation channel.

Active scanning is one method for mobile devices due to lower energy-consumption and shorter discovery time of access points. Empirical test with different mobile devices show that an active scan can be performed at least once every two minutes. Probe request frames contain the MAC address of the sender and, optionally, the SSID of the network of interest. When the frame's SSID field is left blank, all access points can answer the probe request. Various mobile devices can broadcast the directed probe requests for each SSID, and the SSID can be saved in the preferred network list (PNL). Therefore, a mobile device can be recognized and “captured” using Wi-Fi active scans.

In one implementation, a crowd density can be estimated by assuming that each captured unique MAC address corresponds to an average of N people. Thus, the crowd density of one monitor node will be the number of captured unique MAC addresses within the given sampling time frame times the multiplier N divided by the area corresponding to the monitor node. Furthermore, movement through the node's sampling area is measured by capturing the device's specific MAC address at different monitor nodes spaced at distances relative to each other, and determining the traversal path and timing of the device corresponding to the MAC addresses through the respective communication areas of the traffic-monitoring apparatuses 100.

For example using a first method, the number of unique MAC addresses at a first node and the number of unique MAC addresses at a second node neighboring the first node, as shown in FIG. 3 for example, is determined over a predefined time interval. Movement from the first node to the second node is indicated when a unique MAC addresses is detected by the first node prior to the MAC addresses being detected by the second node. Information regarding the flow and speed of traffic through the respective areas corresponding to the two nodes can be obtained by noting the time lag between the earliest detection event by each node, for example. In one implementation, the time difference between the detection of the MAC address by the first and second nodes provides additional information regarding traffic flow. Traffic flow from the second node toward the first node can be determined using the gap (overlap) of the respective communication regions relative to the time difference between the first and last MAC address communications within each communication region. Using statistical analysis, the flow dynamics can be determined from the relative differences between the timing of the MAC addresses.

Using a second method, the relative signal strengthen corresponding to the MAC address can provide additional information to refine estimates of crowd flow and density. Thus, a received signal strength indication (RSSI) value can be used to improve the estimate of the flow of pedestrian/motor-vehicle traffic and provide more accurate estimate of the flow relative to the first method discussed above, which is based on detection timing alone. The traffic flow information obtained using the traffic-monitoring apparatuses 100 includes the unique MAC addresses, the corresponding time stamps of the MAC address communications, and the RSSI values corresponding to each MAC address communication, for example. In one implementation, the proximity to the respective nodes can be estimated by selecting a series of RSSI thresholds and monitoring the transitions of MAC addresses between the predefined RSSI thresholds. Thus, information regarding transition between these threshold regions can be monitored in addition to monitoring the transition between the first node area and the second node area. Because RSSI measurements can have stochastic properties due to multi-path fading, device orientation, and non-isotropic antenna radiation/transmission patterns, Wiener or Kalman filtering can be used smooth the RSSI values corresponding to each MAC address, for example. In one implementation, rather than using coarse-grain discrete steps/tiers of RSSI values/regions, the RSSI is used as a continuous value. Thus, rather than a binary decision whether the MAC address is inside or outside the communication range, the communication range is subdivided into a series of stronger and weaker communication regions to more finely resolve the movements of wireless devices relative to the traffic-monitoring apparatuses 100. In one implementation, the RSSI information is used to select a communication region matching the field of view of the optical camera 120 and the thermal imager 130. Thus, the RSSI selected a communication region corresponds to the same region surrounding the respective apparatus 100 as is sampled by the optical camera 120 and the thermal imager 130.

The RSSI can be obtained using the IEEE 802.11 protocol, for example. According to IEEE 802.1, RSSI is the relative received signal strength in a wireless environment given in arbitrary units. The RSSI is an indication of the power level being received by the antenna. Therefore, the higher the RSSI number, the stronger the signal. Conventionally, there is no standardized relationship of any particular physical parameter to the RSSI reading. In certain implementations, the 802.11 standard does not define any relationship between RSSI value and power level in mW or dBm. In one implementation, RSSI can be used for coarse-grained location estimates. Thus, RSSI can be used to provide measurements indicative of the location of user equipment. When a MAC address is simultaneously detected by multiple traffic-monitoring apparatuses 100 (e.g. three or more traffic-monitoring apparatuses 100), the combined information from the traffic-monitoring apparatuses 100 can used for additional signal processing (e.g., triangulation) to more precisely estimate the location of the user equipment.

In step 432 of method 400, MAC address information from step 430 is used to estimate the combined number of pedestrians and motor vehicles.

As discussed above, one challenge of using wireless device counters for crowd density and flow estimations is that, used by themselves, wireless device counters are unable to distinguish between mixed traffic including both pedestrians and vehicles. Wireless technologies like Bluetooth, RFID, and Wi-Fi can be used to estimate the combined number of vehicles and pedestrian with reasonable accuracy, especially when used in a controlled traffic area and when using RSSI. However to determine the number of motor vehicles excluding pedestrians, the number of pedestrians estimated using the optical camera data, for example, can be subtracted from the estimate of the combined number of pedestrians and motor vehicles.

In step 440 of method 400, the thermal image data from the thermal imager 130 is processed to find regions (e.g. blobs) corresponding to pedestrians and motor vehicles according to the correlation of the thermal image data pixels to known heat signatures of pedestrians and motor vehicles.

While the optical and wireless-device traffic estimation methods can by themselves provide useful estimates of crowd density and flow in several circumstances, in a mixed pedestrian and motor vehicle environment, for example, additional orthogonal information is useful to improve these estimates. In particular, thermal imaging of motor vehicles and pedestrians provides orthogonal information due to the uniqueness of their respective heat signatures. This additional information is especially helpful in those cases where a motor vehicle or pedestrian is not using any of the abovementioned wireless technologies. In such a scenario, detecting the number of vehicles and their speed might be difficult. Therefore, the thermal imager 130 is used to capture the heat signatures of both vehicles and pedestrians.

Vehicles and pedestrians have distinct heat signatures. The heat signature is determined by the temperature distribution, the structural shape, the emissivity, the albedo, and the surrounding radiation sources illuminating the imaged object. Further, the heat signature can include a wavelength (i.e., energy/spectral) dependency that provides additional information in addition to an objects spatial/geometrical heat signature. The imaged heat signatures can be discerned as blobs, and the SVM classifier can be used classify detected heat signatures into pedestrian and vehicle clusters/sets. Combined with the optical image information, the thermal image information from step 442 can improve the classification performed by the SVM classifier in step 422.

FIG. 4 shows that in step 440 the heat-signature based discrimination is performed. This initial discrimination can be performed using spectral information and/or spatial variations in the image. In certain implementations, there is no heat-signature based discrimination performed apart from the blob detection performed in step 442.

In step 442 of method 400, the blob detection is performed with the results of the blob detection being passed to the SVM classifier in step 422. In certain implementations the blob detection step receives classification information back from step 422. The blob detection information together with the SVM classification information is then handed off to steps 444 and 446 respectively to perform estimates of the number of people (e.g., pedestrians) and the number of vehicles (e.g., motor vehicles) respectively. For example, the number of people detected using thermal imager can be averaged with number of people obtained using the optical images. Similarly, the number of vehicles estimated using wireless technologies counter can be averaged with the estimate of the number of vehicles obtained using the thermal imager to obtain an improved estimate of the number of vehicles in step 460. The combined estimate of the number of vehicles can also be calculated using a weighted average of the thermal imager estimate and the wireless counter estimate. For example, various factors my increase the confidence in one detection technique over another. When the weather and time of day is especially hot, for example, heat signatures might tend to wash out resulting in a lower confidence. Similarly, estimations based on optical images might be poorer at night, under low light level conditions, or poor weather conditions such as heavy hog or sand/snow storms. Also, optical detection of pedestrians and/or motor vehicles might yield poorer results for very large crowds relative to smaller crowds due to some pedestrian being obscured in the optical image. In contrast, the wireless device counter might perform better for large crowds to the law of large numbers resulting in greater fidelity in the correspondence between the number of wireless devices and the number of pedestrians and moto vehicles. The weighting of the estimates can be tuned based on empirical and regional observations.

In step 442 for method 400, the blob detection method detects regions of the thermal digital image that have contrasting properties compared with surrounding regions (e.g., properties such as brightness or color). For example, the blob might include a region of an image in which some properties are constant or approximately constant. In this scenario all the points in a blob can be considered to be similar to each other.

Given a predefined property that is expressed as a function of position in the image, there are several methods for the blob detector to categories the regions into blobs. In one implementation, a differential method is used based on derivatives of the function with respect to position. In another implementation, the blob detection method detects the local maxima and minima of the function. The blob detection in step 442 can be performed using one of a Laplacian of Gaussian approach, a difference of Gaussians approach, a determinant of the Hessian approach, a hybrid Laplacian and determinant of the Hessian operator approach, an affine adapted differential approach. a grey-level blobs approach (e.g., a Lindeberg's watershed based algorithm), or a maximally stable extremum regions approach, for example.

There are several advantages of blob detectors. One advantage is to provide complementary information about regions, which is not obtained from edge detectors or corner detectors. Blob detection can be used to determine regions of interest for further processing. These regions could signal the presence of objects or parts of objects in the image domain to be targeted for further image processing (e.g., using the optical image data) such as object recognition and/or object tracking. In histogram analysis, blob descriptor results can be used for peak detection with application to segmentation, for example.

In step 450 of method 400, the estimates of the crowd density and flow of pedestrians from steps 416, 444, and 432 are combined to determine a combined estimate of the pedestrian crowd density and flow. For example, the combined estimate can be a weighted average from the estimates obtained in steps 416, 444, and 432.

In step 460 of method 400, the estimates of the crowd density and flow of pedestrians from steps 432, 446 and 450 are combined to determine a combined estimate of the pedestrian crowd density and flow. In one implementation, the combined estimate of pedestrians and motor vehicles can yield an estimate for the number of motor vehicles by subtracting off the estimated number of pedestrians. In one implementation, the combined estimate can be a weighted average from the motor vehicle estimates obtained using steps 432, 446 and 450.

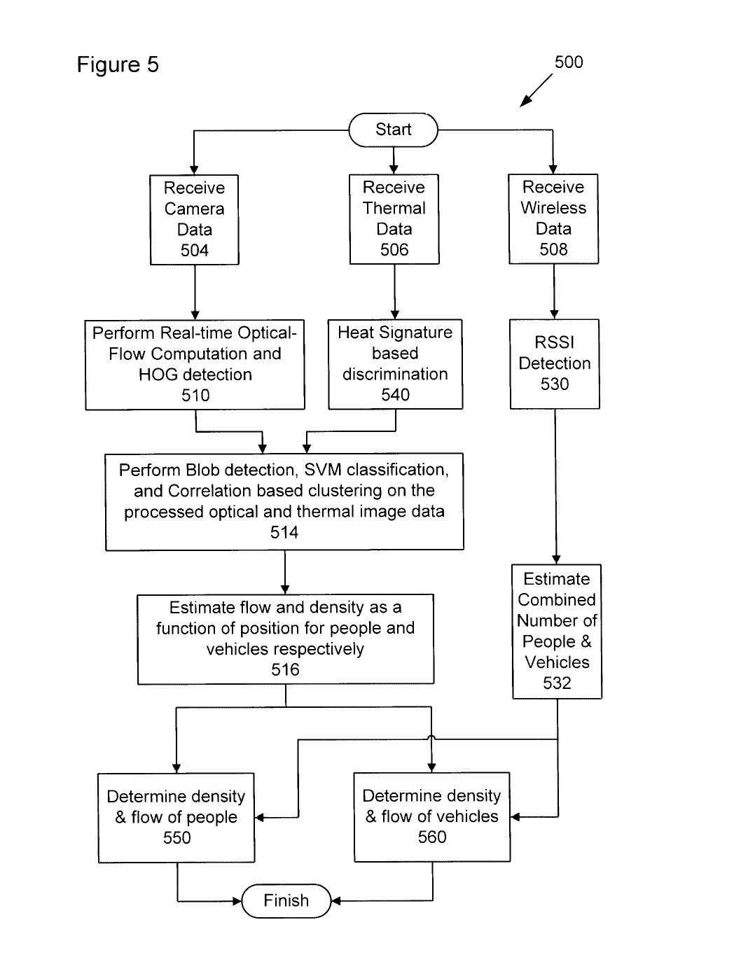

FIG. 5 shows another implementation of a method of estimating traffic density and flow in a mixed traffic environment. In method 500, the first steps are receiving the camera data 504, receiving the thermal data 506, and receiving the wireless data 508.

In step 510 the optical camera data is processed using an integrated optical-flow and HOG detection method. In this method of step 510, the image data is normalized using the gamma and the color values of the images. In one implementation, the images are normalized and preprocessed using the luminance and tristimulus values (i.e., the tristimulus values are three values per pixel corresponding to short wavelengths (e.g., λ=420 nm-440 nm), middle wavelengths (e.g., λ=530 nm-540 nm), and long wavelengths (e.g., 560 nm-580 nm)). Next, image gradients are computed for the intensities and color values in the images. Using these gradients, image regions are categorized into spatial and orientation cells by applying a weighted voting method according to the magnitude and direction of the gradients. This weighted voting method creates a histogram oriented gradient (HOG) representation of the image. In one implementation, the spatial and orientation cells are processed to normalize contrast among overlapping spatial blocks in order to correct for invariance due to edge contrast, illumination, and shadowing.

The optical-flow calculation with Gaussian pyramids can also be performed in step 510 concurrently and integrated with the HOG detection. In one implementation, Gaussian pyramid are used to process the optical flow results to create a series of images. These images are weighted down to smaller images using Gaussian averaging, in which each pixel contains a local average corresponding to a pixel neighborhood on a lower level of the pyramid. The optical flow computation can be performed using the methods discussed in connection with step 410. The optical flow computation calculates motion vectors for all the pixels in a frame using two or more time staggered images. In one implementation, the flow vectors with lesser magnitudes are ignored as background, thus reducing the computational demands. This reduction in computation is possible when the motion between the two images is small. Alternatively, for larger movements, the Gaussian pyramid can be used.

In step 540 of method 500, the thermal image data is processed according to differences in the heat signature, similar to step 440 in method 400.

After performing the optical flow and HOG detection processing in step 510 and the heat signature discrimination in step 540, the respective results are ported into step 514. In step 514, an integrated process of blob detection, SVM classification, and clustering is performed. For example, across the grid of the thermal image data and optical image data, significant variations in the processed data may be represented. These variations may include spatial variations and variation among the HOG, optical flow, and heat signature results, which present complementary information for discrimination purposes. All of these results and variations can be fed into the blob detector (for spatial variations) and the SVM classifier (for all variations), and the SVM classifier can use a kernel method such as a k-means clustering, as discussed above for method 400.

In step 516 of method 500, the pedestrians and motor vehicles classifications from step 514 are used to estimate the density and flow of the pedestrians and motor vehicles is estimated within the image area. In one implementation, only the density and flow of the pedestrians and not motor vehicles is estimated within the image area.

In steps 530 and 532 of method 500, wireless device counting is performed to estimate the combined number of pedestrians and motor vehicles, similar to the steps 430 and 432 respectively.

In step 550 of method 500, the results of steps 516 and 532 are combined to provide a refined estimate of the density and flow of the pedestrians within the detection area.

In step 560 of method 500, the results of steps 516 and 532 are combined to provide a refined estimate of the density and flow of the motor vehicles within the detection area.

The signal processing method and calculation techniques discussed in relation to method 400 can also be used in method 500 and vice versa.

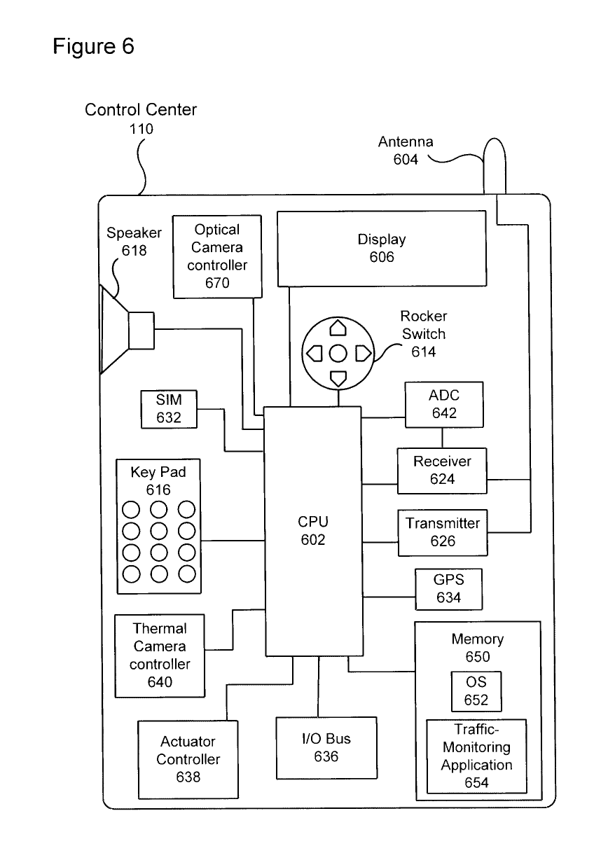

FIG. 6 shows a block diagram illustrating a control center 110 according to one embodiment. In one implementation, the control center 110 can perform the methods 400 and 500 of processing and estimating crowd densities and flow using the optical images, thermal images, and wireless-device data of the traffic-monitoring apparatus 100. In one implementation, the control center 110 can interact with a cloud-computing center through a wireless network to perform the methods and processes discussed herein, e.g., as discussed in reference to methods 400 and 500. Moreover, the methods 400 and 500 described herein can be performed by dividing some computational tasks to be performed by the control center 110, and other of the computational tasks to be performed using cloud computing. For example, in one implementation, less computationally intensive steps can be performed using the control center 110, and more computationally intensive steps can be performed using cloud computing to mitigate the computational and storage burden on the control center 110.

Returning to FIG. 6, the control center 110 provides processing circuitry configured to perform the methods described herein. For example, the control center 110 can include a processor 602 coupled to an internal memory 650, to a display 606 and to a subscriber identity module (SIM) 632 or similar removable memory unit. The processor 602 can be, for example, an ARM architecture CPU such as the Cortex A53 by ARM Inc. or a Snapdragon 810 by Qualcomm, Inc. In one implementation the processor 602 can be an Intel Atom CPU by Intel Corporation. The control center 110 may also have an antenna 604 that is connected to a transmitter 626 and a receiver 624 coupled to the processor 602. In some implementations, the receiver 624 and portions of the processor 602 and memory 650 may be used for multi-network communications. In additional embodiments the control center 110 can have multiple antennas 604, receivers 624, and/or transmitters 626. The control center 110 can also include a key pad 616 or miniature keyboard and menu selection buttons or rocker switch 614 for receiving user inputs. The control center 110 can also include a GPS device 634 coupled to the processor and used for determining time and the location coordinates of the control center 110. Additionally, the display 606 can be a touch-sensitive device that can be configured to receive user inputs. An optical camera controller 670 can be used to acquire digital images from the optical camera 120. A thermal camera controller 640 can be used to acquire digital images from the thermal imager 130.

The processor 602 can be any programmable microprocessor, microcomputer or multiple processor chip or chips that can be configured by software instructions (applications) to perform a variety of functions, including the functions of the various embodiments described herein. In one embodiment, the control center 110 can include multiple processors 602, such as one processor dedicated to cellular and/or wireless communication functions and one processor dedicated to running other applications.

Typically, software applications can be stored in the internal memory 650 before they are accessed and loaded into the processor 602. In one embodiment, the processor 602 can include or have access to an internal memory 650 sufficient to store the application software instructions. The memory can also include an operating system (OS) 652. In one embodiment, the memory also includes traffic-monitoring application 654 that preforms, among other things, the method 400 or 500 as described herein, thus providing additional functionality to the control center 110.

Additionally, the internal memory 650 can be a volatile or nonvolatile memory, such as flash memory, or a mixture of both. For the purposes of this description, a general reference to memory refers to all memory accessible by the processor 602, including internal memory 650, removable memory plugged into the computing device, and memory within the processor 602 itself, including the secure memory.

Further the control center 110 can include an actuator controller 638. For example, the actuator controller 638 can control actuators that are arranged to control the field of view, viewing angle, and depth of focus of the optical camera 120 and the thermal imager 130. Further, in one implementation the field of view of the optical camera 120 and the thermal imager 130 can be scanned to cover an area comparable to the area of wireless devices detected using the wireless terminal 140. In one implementation, the antenna 604 and the receiver 624 and the transmitter 626 can be used to perform the functions of the wireless terminal 140.

In one implementation, the control center 110 can include an input/output (I/O) bus 636 to receive and transmit signal to peripheral devices and sensors, such as the wireless terminal 140.

In one implementation, the traffic-monitoring apparatus is mounted on a pole, such as a light pole, electrical line pole, or a telephone line pole. In one implementation, the traffic-monitoring apparatus is mounted on an unmanned aerial vehicle, such as a quadcopter. In one implementation, the traffic-monitoring apparatus is mounted on a lighter-than-air aircraft, such as a helium balloon or weather balloon that is tethered to the ground via a cable, for example. In one implementation, the traffic-monitoring apparatus is mounted on a wall of a building.

The functions and features of the traffic-monitoring apparatus 100 and methods 400 and 500 described herein can also be executed using cloud computing. For example, one or more processors can execute many of the processing steps performed using the camera data, thermal data, and wireless data, The processors can be distributed across one or more cloud computing centers that communicate with the traffic-monitoring apparatuses 100(1-4) via a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

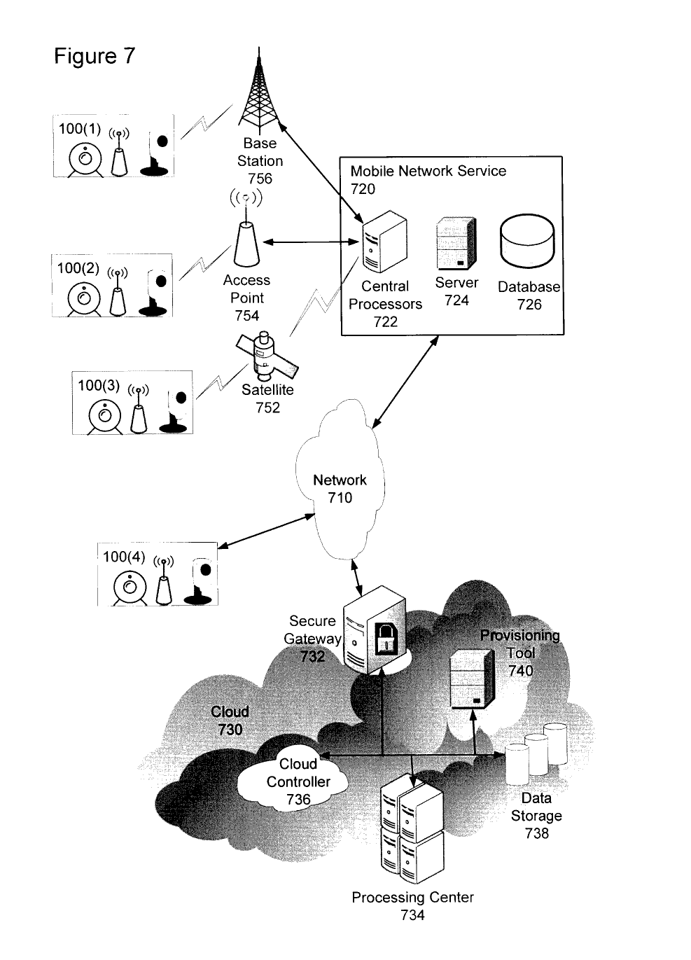

FIG. 7 shows an example of cloud computing, wherein the traffic-monitoring apparatuses 100(1-4) can connect to the internet either using a mobile device terminal or fixed terminal. For example, the traffic-monitoring apparatus 100(1) can connect to a mobile network service 720 through a wireless channel using a base station 756, such as an Edge, 3G, 4G, or LTE Network. Additionally, the traffic-monitoring apparatus 100(2) can connect to a mobile network service 720 through a wireless access point 754, such as a femto cell or Wi-Fi network. Further, the traffic-monitoring apparatus 100(3) can connect to a mobile network service 720 through a satellite connection 752, for example. The traffic-monitoring apparatus 100(4) can access the cloud through a fixed/wired connection, such as a desktop or laptop computer or workstation that is connected to the internet via a network controller, such as an Intel Ethernet PRO network interface card from Intel Corporation of America, for interfacing with network 710. In one implementation, network 710 can be the same network as network 230.

In one implementation, signals from the wireless interfaces (e.g., the base station 756, the access point 754, and the satellite connection 752) are transmitted to a mobile network service 720, such as an EnodeB and radio network controller, UMTS, or HSDPA/HSUPA. Requests from mobile users and their corresponding information are transmitted to central processors 722 that are connected to servers 724 providing mobile network services, for example. Further, mobile network operators can provide service to mobile users including the traffic-monitoring apparatuses 100(1-4), such as authentication, authorization, and accounting based on home agent and subscribers' data stored in databases 726, for example. After that, the subscribers' requests are delivered to a cloud 730 through the internet.

As can be appreciated, the network 710 can be a public network, such as the Internet, or a private network such as an LAN or WAN network, or any combination thereof and can also include PSTN or ISDN sub-networks. The network 710 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The traffic-monitoring apparatuses 100(1-4) connect via the internet to the cloud 730, receive input from the cloud 730 and transmit data to the cloud 730. For example, input received from the cloud 730 can be displayed on the display 606, as shown in FIG. 6, or on the display 210, as shown in FIG. 2. In another example, the data transmitted from the traffic-monitoring apparatus 100 to the cloud 730 can be optical/infrared image data, wireless-device data, or inputs input into the traffic-monitoring apparatus 100 using the key pad 616 or the rocker switch 614, as shown in FIG. 6, or using the input devices 212, as shown in FIG. 2. In an autonomous implementation of the traffic-monitoring apparatus 100, the information received from the cloud 730 can be used in the methods 400 and 500 without being displayed.

In the cloud 730, a cloud controller 736 processes the request to provide users with the corresponding cloud services. These services are provided using the concepts of utility computing, virtualization, and service-oriented architecture.

In one implementation, the cloud 730 is accessed via a user interface such as a secure gateway 732. The secure gateway 732 can, for example, provide security policy enforcement points placed between cloud service consumers and cloud service providers to interject enterprise security policies as the cloud-based resources are accessed. Further, the secure gateway 732 can consolidate multiple types of security policy enforcement, including, for example, authentication, single sign-on, authorization, security token mapping, encryption, tokenization, logging, alerting, and API control. The could 730 can provide, to users, computational resources using a system of virtualization, wherein processing and memory requirements can be dynamically allocated and dispersed among a combination of processors and memories such that the provisioning of computational resources is hidden from the user and making the provisioning appear seamless as though performed on a single machine. Thus, a virtual machine is created that dynamically allocates resources and is therefore more efficient at utilizing available resources. Virtualization creates an appearance of using a single seamless computer even though multiple computational resources and memories can be utilized according increases or decreases in demand. In one implementation, virtualization is achieved using a provisioning tool 740 that prepares and equips the cloud resources such as the processing center 734 and data storage 738 to provide services to the users of the cloud 730. The processing center 734 can be a computer cluster, a data center, a main frame computer, or a server farm. In one implementation, the processing center 734 and data storage 738 are collocated.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

1. A traffic-monitoring controller, comprising:
an interface configured to receive optical-image data and device-count data; and
processing circuitry configured to
obtain, using the interface, the optical-image data representing an optical image of the first area,
obtain, using the interface, the device-count data representing device-identification information corresponding to wireless devices detected by a receiver, wherein the detected wireless devices are within a second area corresponding to an area within a wireless communication range of the receiver, and the device-count data further represents time information corresponding to when the wireless devices were respectively detected,
determine, using the optical-image data, a first pedestrian estimate indicating a number of pedestrians in the first area,
determine, using the device-count data, a pedestrian-and-motor-vehicle estimate indicating a number of pedestrians and motor vehicles in the second area, and
determine, using the first pedestrian estimate and the pedestrian-and-motor-vehicle estimate, a first motor-vehicle estimate of a number of motor vehicles in the first area, wherein
the second area overlaps the first area.

2. The traffic-monitoring controller according to claim 1, wherein the processing circuitry is further configured to
obtain, using the interface, thermal-image data representing an infrared image of the first area,
determine, using the thermal-image data, a second pedestrian estimate of the number of pedestrians in the first area,
determine, using the thermal-image data, a second motor-vehicle estimate of the number of motor-vehicles in the first area,
determine a combined pedestrian estimate of the number of pedestrians in the first area by using the first pedestrian estimate and the second pedestrian estimate, and
determine a combined motor-vehicle estimate of the number of motor vehicles in the first area by using the first motor-vehicle estimate and the second motor-vehicle estimate.

3. The traffic-monitoring controller according to claim 1, wherein the processing circuitry is further configured to determine, using the optical-image data, a pedestrian flow estimate of a flow of the pedestrians within the first area.

4. The traffic-monitoring controller according to claim 1, wherein the processing circuitry is further configured to determine, using the wireless-device data, a wireless-device flow estimate of a flow of the wireless devices through the second area.

5. The traffic-monitoring controller according to claim 2, wherein the processing circuitry is further configured to discriminate, using the thermal-image data, between regions in the first area corresponding to pedestrians and regions in the first area corresponding to motor vehicles.

6. The traffic-monitoring controller according to claim 5, wherein
the regions of the thermal-image data are determined using blob detection, and
the processing circuitry is further configured to process each region of the thermal-image by comparing a heat signatures of the region to known heat signatures of pedestrians and to known heat signatures of motor vehicles, wherein
the comparison of heat signatures is performed using a support vector machine (SVM) classifier.

7. The traffic-monitoring controller according to claim 1, wherein the first pedestrian estimate is performed by
discriminating, using the optical-image data, descriptor blocks within the first area using a Histogram of Oriented Gradients (HOG) algorithm to generate HOG data, and
classifying, using an SVM classifier, whether each descriptor block is classified as a pedestrian or as another classification to generate classified descriptor blocks, and
determining, using the classified descriptor blocks, the first pedestrian estimate.

8. The traffic-monitoring controller according to claim 7, wherein the processing circuitry is further configured to determine the pedestrian flow estimate by
calculating, using the optical-image data, an optical flow of the optical image to generate optical-flow data, and
clustering the optical flow data to generate the pedestrian flow estimate according to flow regions, wherein
the clustering is performed using the classified descriptor blocks corresponding to pedestrians, and
the pedestrian flow estimate represents, for each flow region of the optical image, a number of the pedestrians and a rate of movement of the pedestrians in the respective flow region.

9. The traffic-monitoring controller according to claim 8, wherein the calculation of the optical flow is performed using a Horn and Schunck optical-flow method combined with a Gaussian pyramid method.

10. The traffic-monitoring controller according to claim 8, wherein the clustering of the optical flow is performed by sorting the classified descriptor blocks into k clusters that minimize a within-cluster sum of squares.

11. The traffic-monitoring controller according to claim 1, wherein the processing circuitry is further configured to
obtain a received signal strength indicator (RSSI) corresponding to a wireless device,
compare the RSSI to an RSSI threshold, and
excluding, from the pedestrian-and-motor-vehicle estimate, the device-count data corresponding to wireless devices having the RSSI less than the RSSI threshold.

12. The traffic-monitoring controller according to claim 1, wherein the second area is within the first area.

13. The traffic-monitoring controller according to claim 1, further comprising:
a transmitter and the receiver, wherein
the transmitter and the receiver are configured to transmit and to receive communication signals from another traffic-monitoring controller, wherein communication signals from the another traffic-monitoring controller include wireless-device information of the another traffic-monitoring controller, and
the processing circuitry is further configured to compare the wireless-device information of the another traffic-monitoring controller with the wireless-device information of the traffic-monitoring controller.

14. The traffic-monitoring controller according to claim 4, further comprising:
a transmitter and the recieiver, wherein
the transmitter and the receiver are respectively configured to transmit and to receive communication signals from another traffic-monitoring controller, wherein the communication signals from the another traffic-monitoring controller include wireless-device information of the another traffic-monitoring controller, and
the processing circuitry is further configured to
compare the wireless-device information of the another traffic-monitoring controller with the wireless-device information of the traffic-monitoring controller,
determine the wireless devices that were detected by both the traffic-monitoring controller and the another traffic-monitoring controller, and
compare, for each wireless device detected by both traffic-monitoring controllers, the time information from the traffic-monitoring controller with the time information of the another traffic-monitoring controller to generate time difference data,
generate, using the time difference data, an average speed estimate for wireless devices migrating between the wireless communication ranges of corresponding to the traffic-monitoring controller and the another traffic-monitoring controller, and
the flow estimate of the wireless devices through the second area is estimated using the average speed estimate of wireless devices.

15. The traffic-monitoring controller according to claim 1, wherein the device-identification information includes a MAC address of each detected wireless device.

16. A traffic-monitoring apparatus, comprising:
an optical camera configured to image a first area and to generate optical-image data representing an optical image of the first area;
an infrared camera configured to image the first area and generate thermal-image data representing an infrared image of the first area;
a receiver configured to
receive device-identification information corresponding to wireless devices within a second area, the second area being within a wireless communication range of the receiver, and
generate wireless-device data representing the device-identification information and representing a time that the device-identification information was received; and
processing circuitry configured to
determine, using the optical-image data, a first pedestrian estimate indicating a number of pedestrians in the first area,
determine, using the wireless-device data, a pedestrian-and-motor-vehicle estimate indicating a number of pedestrians and motor vehicles in the second area, and
determine, using the a first pedestrian estimate and the pedestrian-and-motor-vehicle estimate, a first motor-vehicle estimate of a number of motor vehicles in the first area,
determine, using the thermal-image data, a second pedestrian estimate of the number of pedestrians in the first area,
determine, using the thermal-image data, a second motor-vehicle estimate of the number of motor-vehicles in the first area,
determine a combined pedestrian estimate of the number of pedestrians in the first area by using the first pedestrian estimate and the second pedestrian estimate, and
determine a combined motor-vehicle estimate of the number of motor vehicles in the first area by using the first motor-vehicle estimate and the second motor-vehicle estimate.

17. A traffic-monitoring method, comprising:
imaging a first area, using an optical camera, to generate optical-image data representing an optical image of the first area;
imaging a first area, using an infrared camera, to generate thermal-image data representing an infrared image of the first area;
receiving, using a receiver, device-identification information corresponding to wireless devices within a second area in a wireless communication range of the receiver;
generating device data representing the device-identification information and representing a time that the device-identification information was received;
determining, via the processing circuitry and using the optical-image data, a first pedestrian estimate indicating a number of pedestrians in the first area;
determining, via the processing circuitry and using the wireless-device data, a pedestrian-and-motor-vehicle estimate indicating a number of pedestrians and motor vehicles in the second area; and
determining, via the processing circuitry and using the a first pedestrian estimate and the pedestrian-and-motor-vehicle estimate, a first motor-vehicle estimate of a number of motor vehicles in the first area, wherein
the second area overlaps the first area.

18. The traffic-monitoring method according to claim 17, further comprising:
imaging a first area, using an infrared camera, to generate thermal-image data representing an infrared image of the first area;
determining, using the thermal-image data, a second pedestrian estimate of the number of pedestrians in the first area;
determining, using the thermal-image data, a second motor-vehicle estimate of the number of motor-vehicles in the first area;
determining a combined pedestrian estimate of the number of pedestrians in the first area by using the first pedestrian estimate and the second pedestrian estimate;
determining a combined motor-vehicle estimate of the number of motor vehicles in the first area by using the first motor-vehicle estimate and the second motor-vehicle estimate; and
comparing heat signatures of regions of the thermal-image data to known heat signatures of pedestrians and to known heat signatures of motor vehicles,
wherein the comparison of heat signatures is performed using a support vector machine (SVM) classifier.

19. The traffic-monitoring method according to claim 17, further comprising:
determining, using the optical-image data, a pedestrian flow estimate of a flow of the pedestrians within the first area a first area;
discriminating, using the optical-image data, descriptor blocks within the first area using a Histogram of Oriented Gradients (HOG) algorithm to generate HOG data;
discriminating, using the SVM classifier, descriptor blocks that correspond to the pedestrians to generate classified descriptor blocks;
determining, using the classified descriptor blocks, the first pedestrian estimate;
calculating, using the optical-image data, an optical flow of the optical image to generate optical-flow data; and
clustering the optical flow data to generate the pedestrian flow estimate, wherein
the clustering is performed by sorting the classified descriptor blocks into k clusters that minimize the within-cluster sum of squares, and
the pedestrian flow estimate represents for each of the regions of the optical image a number of the pedestrians and a rate of movement of the pedestrians in the respective region.

20. The traffic-monitoring method according to claim 17, further comprising:
receiving communication signals from another traffic-monitoring apparatus, wherein communication signals from the another traffic-monitoring apparatus include wireless-device information of the another traffic-monitoring apparatus; and
comparing the wireless-device information of the another traffic-monitoring apparatus with the wireless-device information of the traffic-monitoring apparatus.
